(19) United States
(12) Patent Application Publication
(10) Pub. No.: US 2021/0370834 A1
(43) Pub. Date: Dec. 2, 2021

(54) QUICK RELEASE MIRROR MOUNT

(71) Applicant: OMIX-ADA, INC., Ann Arbor, MI (US)

(72) Inventors: Patrick W. Bennett, Gainesville, GA (US); Jesse T. Neal, Atlanta, GA (US); Eric Russell, Lilburn, GA (US); Amir Rahbaripour, Atlanta, GA (US); Alain Eboli, Sunwanee, GA (US)

(21) Appl. No.: 17/400,934

(22) Filed: Aug. 12, 2021

Related U.S. Application Data
(62) Division of application No. 16/026,821, filed on Jul. 3, 2018.

(51) Int. Cl. B60R 1/078

(52) U.S. Cl. CPC B60R 1/078

(57) ABSTRACT

An accessory adapter comprising a vehicle side, attachable to one or more hinges of a vehicle, and an accessory side, wherein the accessory side is configured to accept an accessory. Including a method of attaching the accessory adapter to a vehicle.

### FIELD

The present teachings relate generally to aftermarket parts for vehicles and more specifically to accessory adapters for open, off-road vehicles, and preferably off-road vehicles with removable doors, movable windows, or both.

### BACKGROUND

Off-road vehicles such as those found in the Jeep®, Wrangler®, Wrangler JK®, and Wrangler JL® brands are popular among outdoor enthusiasts because of their rugged build and appearance and ability to move over terrain where other vehicles cannot tread. In addition, the aforementioned brands of vehicles provide owners with modular capabilities, which is fueled by a robust aftermarket parts and accessories industry.

Often when off-roading or during conventional commuting, owners of off-road vehicles, such as Jeep®, Wrangler®, Wrangler JK®, and Wrangler JL® brand vehicles, remove the vehicle's doors in order to have a freeing and exhilarating driving experience. These vehicles may have factory side-view mirrors attached to the doors and removing the doors to these vehicles necessarily results in removing the side-view mirrors. Some states require vehicles to have one or more operational side-view mirrors when traveling on public roads by law and non-compliance may result in fines. Owners may also prefer to drive with side-view mirrors as a matter of preference. Thus, owners of these vehicles may wish to outfit their vehicle with one or more mirrors that may be functional when the door is removed.

Aftermarket accessory adapters are available for off-road vehicles, such as Jeep®, Wrangler®, Wrangler JK®, and Wrangler JL® brand vehicles, which enable the owner to mount an accessory, such as a mirror, to the vehicle while the door is removed. In some instances, accessory adapters are mounted to hinges, such as windshield hinges, with fasteners such as screws. Use of these types of accessory adapters necessitate disassembly of the windshield frame, fastening to the windshield hinge with tools and in a manner that precludes quick and easy attachment and detachment. Examples of some accessory adapters, particularly the use of which requires disassembly of the window frame, use of tools, and precludes quick attachment and detachment, may be found in U.S. Pat. Nos. 4,818,088 and 9,555,742 and U.S. Patent Application No. 2014/0239143 A1 the teachings of which are incorporated by reference herein for all purposes.

In some instances, accessory adapters utilize the structure of the door, such as a side window slot or a flanged portion of the door structure, to mount to the vehicle. Use of these types of accessory adapters precludes use of the accessory adapter while the door is removed. Examples of some accessory adapters, particularly the use of which requires the door to be attached, may be found in U.S. Pat. No. 3,166,238 and International Publication No. WO 2016/204969 A1 the teachings of which are incorporated by reference herein for all purposes.

In some instances, accessory adapters utilize hinge assemblies, such as those found to attach doors to door frames, to attach the accessory mounts. Use of these types of accessory adapters preclude the option of keeping the accessory adapter connected to the vehicle while the doors are attached. Examples of some accessory adapters, particularly the use of which requiring the door to be removed, may be found in U.S. Pat. Nos. 5,516,073 and 7,267,384 the teachings of which are incorporated by reference herein for all purposes.

In some instances, accessory adapters attach to and are offset from hinge assemblies such as fold-down windshield hinges. Use of these types of accessory adapters may require structural support arms or other structure that would impede the use of a fold-down function of a windshield frame. Examples of some accessory adapter, particularly the use of which prevents use of a fold-down function of a windshield frame, may be found in U.S. Patent Application No. 2014/0239143 A1 the teachings of which are incorporated by reference herein for all purposes.

It would be attractive to provide an accessory adapter that does not necessitate the use of tools to attach the accessory adapter to the vehicle. It would be attractive to provide an accessory adapter that does not require a step of first disassembling the window frame. It would be attractive to provide an accessory adapter that enables quick attachment and detachment to and from the vehicle. It would be attractive to provide an accessory adapter that enables attachment to the vehicle and attachment of an accessory, such as a mirror, while the doors of the vehicle are removed. It would be attractive to provide an accessory adapter that enables the accessory adapter to remain attached to the vehicle while the doors are on the vehicle. It would be attractive to provide an accessory adapter that enables use of a fold-down windshield frame while the accessory adapter is attached.

### SUMMARY

The present teachings provide an accessory adapter comprising a vehicle side, attachable to one or more hinges of a vehicle, and an accessory side, wherein the accessory side configured to accept an accessory.

The present teachings provide a method of attaching an accessory adapter to a vehicle comprising fastening a vehicle side of the accessory adapter to one or more windshield hinges, and attaching an accessory to the accessory side of the accessory adapter.

The present teachings provide an accessory adapter that does not necessitate the use of tools to attach the accessory adapter to the vehicle. The present teachings provide an accessory adapter that does not require a step of first disassembling the window frame. The present teachings provide an accessory adapter that enables quick attachment and detachment to and from the vehicle. The present teachings provide an accessory adapter that enables attachment to the vehicle and attachment of an accessory, such as a mirror, while the doors of the vehicle are removed. The present teachings provide an accessory adapter that enables the accessory adapter to remain attached to the vehicle while the doors are on the vehicle. The present teachings provide an accessory adapter that enables use of a fold-down windshield frame while the accessory adapter is attached.

### BRIEF DESCRIPTION OF DRAWINGS

FIG. 1A illustrates a perspective view of a vehicle.

FIG. 1B illustrates the vehicle of FIG. 1A with the door removed.

FIG. 1C illustrates a partial view of the vehicle of FIG. 1B.

FIG. 2 illustrates a perspective view of an accessory adapter and an accessory.

FIG. 3A illustrates a perspective view of an accessory adapter and an accessory.

FIG. 3B illustrates a partial, exploded view of the accessory and accessory adapter of FIG. 3A.

FIG. 4 illustrates an assembled accessory adapter and accessory.

FIG. 5A illustrates removal of a factory fastener from one or more windshield hinges.

FIG. 5B illustrates assembly of an accessory adapter and accessory to one or more windshield hinges.

FIG. 6 is a perspective view of a fastening article.

FIG. 7 is a perspective view of a cap.

FIG. 8A illustrates a fragmentary perspective view of the step of removing a factory fastener from one or more windshield hinges.

FIG. 8B illustrates a fragmentary perspective view of the step of attaching an accessory adapter to one or more windshield hinges.

FIG. 8C illustrates a fragmentary perspective w of the step of screwing an accessory adapter onto a hinge pin.

FIG. 8D illustrates a fragmentary perspective view of the step of inserting an accessory into an accessory adapter and attaching a fastening article.

FIG. 8E illustrates a fragmentary perspective view of the step of tightening a fastening article in an accessory adapter.

FIG. 8F illustrates a fragmentary perspective view of the step of inserting a cap in an accessory adapter.

FIG. 9A illustrates the step of attaching an accessory to an accessory adapter.

FIG. 9B illustrates the step of aligning an accessory adapter with one or more windshield hinges.

FIG. 9C illustrates the step of attaching are accessory adapter to one or more windshield hinges.

FIG. 10A illustrates a fragmentary perspective view of an accessory and accessory adapter.

FIG. 10B illustrates the step of aligning an accessory adapter with one or more windshield hinges.

FIG. 10C illustrates the step of attaching an accessory adapter to one or more windshield hinges.

FIG. 11A illustrates a fragmentary perspective view of an accessory and accessory adapter.

FIG. 11B illustrates the step of aligning an accessory adapter and factory fastener with one or more windshield hinges.

FIG. 11C illustrates the step of inserting an accessory in an accessory adapter.

### DETAILED DESCRIPTION

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The present teachings relate to an accessory adapter for a vehicle. The vehicle may be any vehicle customarily driven with the doors removed. Preferably, the vehicle is a utility vehicle, a sport utility vehicle, an off-road vehicle, or an all-terrain vehicle. More particularly, the vehicle may be of the Jeep®, Wrangler®, Wrangler JK®, Wrangler JL®, or a combination thereof brands. The vehicle may include one or more vehicle moving members, one or more vehicle frame members, and one or more windshield hinges.

The one or more vehicle frame members may function to provide structure to the vehicle and support for the one or more vehicle moving members. Preferably, the one or more vehicle frame members may include one or more A-pillars, one or more cowls, or a combination thereof.

The A-pillar may function to provide vertical support along the vehicle's windows and doors located at the front of the vehicle, adjacent the front wheel well. The A-pillar may be a structural element that supports the load exerted by the door. The one or more vehicle frame members may bear a load of about 50 kg or more, preferably about 75 kg or more, or more preferably about 100 kg or more. The one or more vehicle frame members may bear a load of about 500 kg or less, about 350 kg or less, or about 200 kg or less.

The cowl may function to provide structural support for the windshield frame. The cowl may be a structural component attached to the vehicle frame. The cowl may be a structure to which the windshield frame is attached. The cowl may extend along the hood of the vehicle. The cowl may enable attachment of a foldable or non-foldable windshield frame. Preferably, the cowl enables attachment of one or more vehicle moving members that are preferably a foldable windshield.

The one or more vehicle moving members may function to provide modular adjustment of one or more components of the vehicle according to the aesthetic and experience desires of the user. The one or more moving members may be two, three, four, five, six, or seven doors or a windshield frame.

The door may function to selectively provide security by enclosing the cab of the vehicle. The door may include side doors located on either side of the vehicle. The door may attach to the vehicle along the A-pillar. The door may be removable by lifting out of the door hinge. The door may be OEM doors or aftermarket doors. The doors may have an attached side-view mirror.

The windshield frame may function to hold the windshield in place and enable selective use of the windshield. The windshield frame, may be foldable or non-foldable. For example, if the windshield frame is foldable, the windshield frame rotates about a path of windshield rotation from an upright, usable position to a stowed position against the hood of the car. The windshield frame may be connected to and rotatable about one or more windshield hinges.

The one or more windshield hinges may function to provide a hinged interface between one or more vehicle moving members and one or more vehicle frame members. The one or more windshield hinges may provide a hinged interface between the windshield frame and the cowl. More specifically, the one or more windshield hinges may rotatably connect the windshield frame to the cowl. The one or more windshield hinges may include a pin body, a hinge pin, a hinge sleeve, or a combination thereof. Preferably, the one or more windshield hinges include one or more pin bodies, one or more hinge pins, one or more hinge sleeves, or a combination thereof. More preferably, the one or more windshield hinges include a pin body connected to a hinge pin that extends cantilever from the pin body, a hinge sleeve that receives the hinge pin, and a fastener that connects to the hinge pin, the hinge sleeve, or both.

The pin body may function to create a rotatable connection. Preferably, the pin body creates a rotatable connection between a vehicle frame member and a windshield frame. The pin body may be rotatable and connect to a static hinge pin. The pin body may be movable about the hinge pin. The pin body may connect directly to one or more vehicle moving members or one or more vehicle frame members and provide support for the hinge pin. The pin body may include a bracket that connects to one or more vehicle moving members or one or more vehicle frame members. The pin body may include a hinge pin. The pin body may be a structure exposed to the exterior of the vehicle. The pin body may form a seamless, aesthetically pleasing connection with the hinge sleeve. A hinge pin may connect to the pin body and extend cantilever from the pin body.

The hinge pin may function to rotate within the hinge sleeve. The hinge pin may remain static and a hinge sleeve may rotate about the hinge pin. The hinge pin may be accepted by the hinge sleeve. The hinge pin may be threaded or unthreaded. The hinge pin may be partially threaded and partially unthreaded. Preferably, the hinge pin is at least partially threaded. The hinge pin may connect to a fastener, an accessory adapter, or both. The hinge pin when connected to a fastener, an accessory adapter, or both may remain static while a hinge sleeve rotates about the hinge pin. The hinge pin when connected to a fastener, an accessory adapter, or both may rotate with the pin body. The hinge pin may extend fully or partially through the hinge sleeve.

The hinge sleeve may function to provide a rotatable connection. The hinge sleeve may connect directly to one or more vehicle moving members or one or more vehicle frame members. The hinge sleeve may receive the hinge pin. The hinge sleeve may be located adjacent to the pin body. The hinge sleeve and the hinge pin may form a complementary fit. The hinge sleeve may include a bracket that connects to one or more vehicle moving members or one or more vehicle frame members.

The factory fastener may function to keep the hinge pin attached to the hinge sleeve. The factory fastener may be a screw, bolt, threaded fastener, torx bolt, a nut, or a combination thereof. Preferably the factory fastener is a torx bolt. The factory fastener may thread over the hinge pin. The factory fastener may fit in the hinge sleeve so that the windshield is rotatable about the factory fastener or the hinge pin.

The path of windshield rotation may be an arc path with the rotational axis aligning with the longitudinal axis of the hinge pin.

The accessory adapter may function to connect an accessory to the vehicle. The accessory adapter may connect to a hinged interface such as one or more windshield hinges or one or more door hinges. Preferably, the accessory adapter connects to one or more windshield hinges. The accessory adapter may enable use of a fold-down windshield function of a vehicle while the accessory adapter is attached to the vehicle. The accessory adapter may enable attachment of an accessory while a door of the vehicle is removed. The accessory adapter may be attached to or detached from the vehicle without use of a tool. The accessory adapter may provide quick release, quick connect, or both. The accessory adapter may remain connected to the vehicle after attachment. The accessory adapter may replace the function of the factory fastener or be used in conjunction with the factory fastener. Once installed the accessory adaptor may remain connected to the vehicle. The accessory adaptor may remain in the vehicle when the accessory is removed. An accessory adapter may be connected to a first side of a vehicle (e.g., driver side), a second side of a vehicle (e.g., passenger side), or both. The accessory adapter may be threaded from a vehicle side to an accessory side or may be free of threading. When the accessory adapter is connected to a vehicle and an accessory, the accessory adapter may be substantially hidden from view. The accessory adapter may include a vehicle side, an accessory side, or both.

The vehicle side may function to connect the accessory adapter to an attachment point on a vehicle and preferably to the one or more windshield hinges. The vehicle side may have a diameter substantially similar to the factory fastener or substantially similar to the hinge sleeve. The vehicle side may include a hinge bore, a support sleeve, or both. The vehicle side may include a flange surrounding the hinge bore. The vehicle side may connect to the hinge pin or hinge sleeve. Preferably, the vehicle side connects to the hinge pin. The vehicle side may fit within the hinge sleeve or over the hinge sleeve. If the vehicle side fits within the hinge sleeve, the vehicle side may extend fully into the hinge sleeve or partially into the hinge sleeve. Preferably, the vehicle side extends into the hinge sleeve the length of the hinge pin that is threaded (e.g., 2 mm or more, 5 mm or more, 1 cm or more, 2 cm or more, 10 cm or less, or 5 cm or less). The vehicle side may have a cross-sectional length (e.g., diameter) that is less than a cross sectional length of the adapter side. The adapter side may form a shoulder at a base of the vehicle side so that the vehicle side may only be inserted a predetermined distance. The shoulder may determine a length of the vehicle side. The shoulder may be a stop that prevents further insertion of the vehicle side into the hinge sleeve. The vehicle side may have a donut shape, be a toroid, or both so that the hinge pin is inserted into the vehicle side and a hinge sleeve extends around an outside of the vehicle side. The vehicle side may have a hinge bore that receives the hinge sleeve, the hinge pin, or both.

The hinge bore may function to receive the factory fastener, which connects to the hinge pin and affixes the accessory adapter to the one or more windshield hinges. The hinge bore may abut the hinge sleeve so that the accessory adapter and the hinge sleeve may be fixedly connected together. The hinge bore may be threaded or unthreaded. Preferably, the hinge bore is threaded. The hinge bore may be threaded and form a threaded connection with the factory fastener. If unthreaded, the hinge bore may accept a factory fastener, which may pass through the hinge bore and connect to the hinge pin. The hinge bore may extend part of the way from the vehicle side to the accessory side or the hinge bore may extend from the vehicle side to the accessory side.

The support sleeve may function to provide support for the accessory adapter. The support sleeve may extend cantilever over the hinge sleeve, pin body, or both. The support sleeve may extend cantilever from the vehicle side of the accessory adapter. The support sleeve may be a segment of the accessory adapter that extends from the portion of the accessory adapter that is intermediate the female portion and the hinge sleeve. The support sleeve may remain in contact with the one or more windshield hinges while the male portion is added or removed from the accessory adapter. The support sleeve may extend over a portion or the entirety of the one or more windshield hinges. The support sleeve may abut the interface of the one or more windshield hinges and the windshield frame, thereby preventing rotation of the accessory adapter. The support sleeve may guide the correct alignment of the accessory adapter, particularly in the case that the female rotation inhibitor or male rotation inhibitor of the accessory adapter is keyed. The support sleeve may structurally support the accessory adapter, accessory, or a combination thereof by preventing rotational motion where the fulcrum is the contact point between the one or more windshield hinges and the vehicle side of the accessory adapter.

The accessory side may function to provide structure for a user to attach or remove an accessory from the accessory adapter. The accessory side functions to prevent rotational movement of the accessory once the accessory is connected to the accessory adapter, the hinge sleeve, or both. The vehicle side may have a gripping region so that the accessory adapter may be hand tightened. The gripping region of the vehicle side may be knurled, roughed, grooved, stippled, studded, toothed, shaped with gripping surfaces, or a combination thereof. The vehicle side may have a shape that is square, pentagonal, hexagonal, heptagonal, octagonal, symmetrical, asymmetrical include one or more flat walls, be “D” shaped, a combination thereof. The accessory side may be threaded along all or a portion of a length of the exterior or interior of the accessory side. The accessory side may be threaded along the entirety of the length or a portion of the length of the exterior of the accessory side. The accessory side may be free of an accessory bore to receive a portion of an accessory. The accessory side may be free of threads. The accessory side may include a connection member. The connection member may be a ball joint. The accessory side may extend into a bore of the accessory. The vehicle side, accessory side, or both may include an accessory bore, a locking mechanism, or a combination thereof. The accessory side may be an on opposite side or end of an accessory adapter as an accessory bore.

The accessory bore may function to accept the accessory. The accessory bore may include a male rotation inhibitor. The accessory bore may be straight or tapered. Preferably, the accessory bore is tapered. The accessory bore may extend fully or partially through the accessory side. The accessory bore may be a void within the accessory side that allows lateral rotation of the male portion within the accessory bore. The accessory adapter may be free of a bore. The accessory bore may provide a complimentary fit to a male segment of an accessory.

The female rotation inhibitor may function to prevent rotation of a male rotation inhibitor when the female rotation inhibitor and the male rotation inhibitor are in communication. The female rotation inhibitor may be part of the accessory adapter, the accessory, or both. When the female rotation inhibitor is part of the accessory adapter the male rotation inhibitor is part of the accessory or vice versa. The female rotation inhibitor functions to prevent rotation of the male segment of the accessory while inside the accessory adapter. Further, the female rotation inhibitor functions to allow the vehicle owner to adjust the accessory to a desired orientation. The female rotation inhibitor may be any structure that prevents rotation. The female rotation inhibitor may be tapered, knurled, roughed, keyed, or a combination thereof. Preferably, the female rotation inhibitor is keyed to the male rotation inhibitor so that once a connection is formed the male rotation inhibitor cannot be rotated relative to the female rotation inhibitor or vice versa. For example, the male rotation inhibitor may include one or more grooves and one or more recesses and the grooves may extend into a recess of a female rotation inhibitor and the recesses may receive a groove of the female rotation inhibitor. The female rotation inhibitor and the male rotation inhibitor may be complementary in shape, have a complementary fit, be a mirror image, or a combination thereof so that once connected movement of the accessory relative to the accessory adapter or hinge sleeve is prevented. The female rotation inhibitor may be indexed at discrete intervals or able to be fixed at any rotational position. The indexing may be formed around 360 degrees or less, about 180 degrees or less, about 90 degrees or less, or about 45 degrees or less of the male segment. Preferably, the female rotation inhibitor is indexed 380 degrees. The female rotation inhibitor provides a complementary fit to a male rotation inhibitor.

The locking mechanism may function to prevent axial movement of the accessory, removal of the accessory from the accessory adapter, rotational movement of the accessory, or a combination thereof. The locking mechanism may include one or more fastener bores, a fastening article, or a combination thereof. The locking mechanism may include or be a spring loaded ball and socket, a quick clamping shaft collar, a quick coupler and plug style mechanism, a pin and groove, a detent pin and through-hole, a hairpin and through-hole, a cotter pin and through-hole, a screw, a set screw, a threaded member, or a combination thereof. Preferably, the locking mechanism is a pin and groove. The locking mechanism may be a nut that closes the socket over the ball of a ball joint. The locking mechanism may include one or more fastener bores and a fastening article.

One or more fastener bores may function to accept a fastener or a locking mechanism. The one or more fastener bores may be threaded or free of threads. Preferably the one or more fastener bores is threaded. The accessory side may include one, two, three, four, or more fastener bores. The location of the one or more fastener bores may be at any location about the circumference of the accessory side or anywhere along the length of the accessory side of the accessory adapter. Preferably, the locations of the one or more fastener bores are at regular intervals about the circumference of the accessory side such that at least one of the one or more fastener bores is accessible. The one or more fastener bores may also be located on the accessory.

The fastening article may function to bias against the accessory. The fastening article may include a locking member, a fastener head, or a combination thereof. The fastening article may include a screw or a nut. The fastening article may be an anti-vibration device. The fastening article may assist in maintaining a locked state. The fastening article may be a lock washer, a bias member, an elastomeric member, a metal bias member, or a combination thereof. More specifically, the fastening article may be a nut that is screwed against or in contact with the accessory or a screw that extends through the male segment of the accessory.

The locking member may function to contact the male segment of the accessory through the one or more fastener bores and prevent axial movement of the accessory. The locking member may function to prevent axial movement of the accessory and the accessory adapter relative to each other. The locking member may contact the accessory, the accessory adapter, or both to prevent axial movement. The locking member may be a portion of the locking mechanism that contacts the accessory, the accessory adapter, or both. The locking member may be threaded or unthreaded. The locking member may be a pin or a screw.

The fastener head may function to aid the user in applying the fastening article to the locking mechanism. The fastener head may be a surface or structure that enables gripping of the fastening article by the fingers. The fastener head may allow for movement of the fastening article without the use of tools. The fastener head may have a grip-enhancing feature such as stippling, knurling, roughing, or grooves.

The cap may function to fill the accessory bore when an accessory is not in the accessory bore. The cap functions to prevent axial movement of the accessory adapter when the accessory adapter is not in use. The cap may securely fit into the accessory bore such that it does not dislodge during use of the vehicle. The cap may provide a water-tight seal.

The cap insert may function to fix the cap to the accessory adapter. The cap insert may have a diameter substantially similar to the factory fastener. The cap insert fits securely within the accessory bore. The cap insert may screw, snap, or slide into the accessory bore.

The cap head may function to allow insertion and removal of the cap. The cap head may be low-profile or substantial. The cap head may be decorative or plain. The cap head may have a structure enabling prying the cap from the accessory bore without excessive effort or damaging the cap head.

The accessory may include any number of aftermarket accessories for Jeep®, Wrangler®, Wrangler JK®, and Wrangler JL® brand vehicles. More specifically, the one or more accessories may include traditional light brackets, mirrors, light bars, and other traditional accessories. Preferably, the accessory is a mirror. The accessory may include an accessory body, a lateral support, a male segment, a female segment, a male rotation inhibitor, a female rotation inhibitor, a connection member, a locking mechanism, a groove, one or more fastener bores, or a combination thereof.

The accessory body may function as the functional part of the accessory. The accessory body may be lights or a mirror. Preferably, the accessory body is a mirror.

The lateral support may function to provide a connection between the male segment and the accessory body. The lateral support may run against the profile of the vehicle or be offset from the vehicle. The lateral support may extend laterally against the A-pillar. The lateral support may withstand loads of about 50 kg or more, about 75 kg or more, or about 100 kg.

The male segment may function to be accepted by the female segment. The male segment may include a male rotation inhibitor, a groove, or a combination thereof. The male segment may include a through-hole that accepts the fastening article. The male segment may be threaded or un-threaded. The male segment may be located on the accessory adapter or the accessory.

The female segment may function to accept the male segment. The female segment may be the accessory bore. The female segment may include the female rotation inhibitor. The female segment may be threaded or un-threaded. The female segment may be located on the accessory adapter or the accessory.

Male rotation inhibitor may function to prevent rotation of a female rotation inhibitor when the male rotation inhibitor and the female rotation inhibitor are in communication. The male rotation inhibitor may be part of the accessory adapter, the accessory, or both. When the male rotation inhibitor is part of the accessory adapter the female rotation inhibitor is part of the accessory or vice versa. The male rotation inhibitor functions to prevent rotation of the accessory relative to the accessory adapter. Further, the male rotation inhibitor functions to allow the vehicle owner to adjust the accessory to a desired orientation. The male rotation inhibitor may be any structure that prevents rotation. The male rotation inhibitor may be tapered, knurled, roughed, keyed, or a combination thereof. Preferably, the male rotation inhibitor is keyed to the female rotation inhibitor so that once a connection is formed the female rotation inhibitor cannot be rotated relative to the male rotation inhibitor or vice versa. For example, the female rotation inhibitor may include one or more grooves and one or more recesses and the grooves may extend into a recess of a male rotation inhibitor and the recesses may receive a groove of the male rotation inhibitor. The male rotation inhibitor may be indexed at discrete intervals or able to be fixed at any rotational position. The indexing may be formed around the male segment no less than 360 degrees, no less than 180 degrees, no more than 90 degrees, or no more than 45 degrees. Preferably, the male rotation inhibitor is indexed 360 degrees. The male rotation inhibitor provides a complimentary connection to the female rotation inhibitor.

The connection member may function to connect the lateral support to the accessory adapter and enable free rotation of the accessory adapter. The connection member may be a component separate from the lateral support or integrated into the lateral support or both. For example, the connection member may comprise a ball and socket where the ball is located on the accessory adapter and the complimentary socket is located on the lateral support or vice versa. The ball may be friction fit within the socket so that the socket allows some movement but when an application of force ceases the ball maintains its position. The connection member may include a locking mechanism that allows for free movement while unlocked and fixes the position of the lateral support when locked. The locking mechanism may include segments that extends over the ball and a fastener article that screws over the segments. The segments may extend, toward the one or more windshield hinges, substantially over the ball. The segments may substantially surround the circumference of the ball. The segments may be threaded to accept a fastening article. The segments may close onto the ball when the fastener is tightened on the segments. The segments may be separated by a space so that they may close over the ball and deformation of the segment doesn't impede the deformation of the adjacent segment. The ball may screw, snap, or lock onto the lateral support. The ball may snap into a connection with the accessory body.

The groove may function to accept the locking member. The groove may extend around the entire circumference of the male segment or a portion of the circumference of the male segment. The groove may be located at any point along the length of the male segment. The groove may be aligned with the one or more fastener bores when the male segment is fully inserted in the accessory bore.

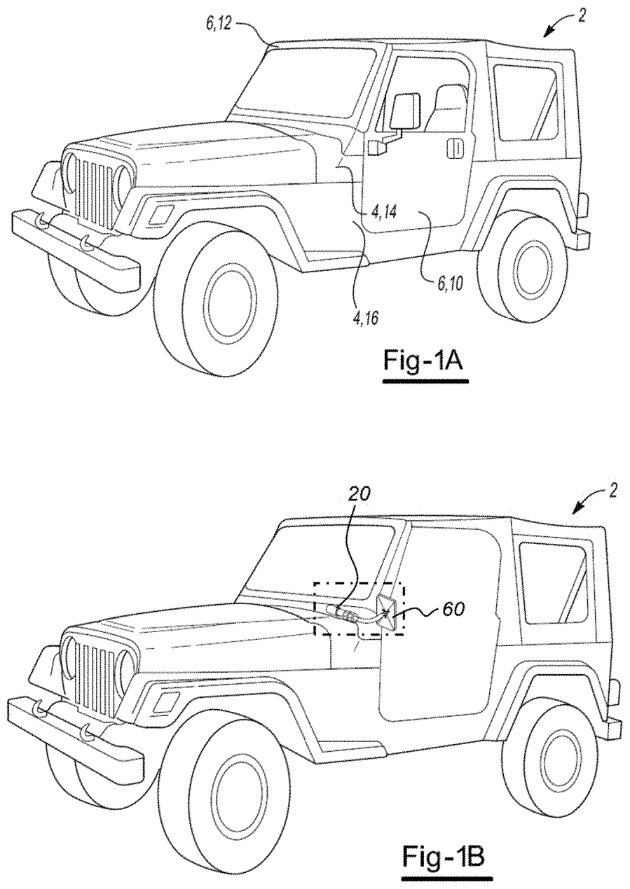

FIG. 1A shows a vehicle 2 having one or more vehicle frame members 4 including a cowl 14 and an A-pillar 16. The vehicle 2 further comprises one or more vehicle moving members 6 including a windshield frame 12 and a door 10.

FIG. 1B shows the vehicle 2 of FIG. 1A with the door (not shown) removed and accessory 60 attached to one or more windshield hinges 20.

FIG. 1C shows partial view of the vehicle 2 of FIG. 1B including an accessory 60 installed on the one or more windshield hinges 20.

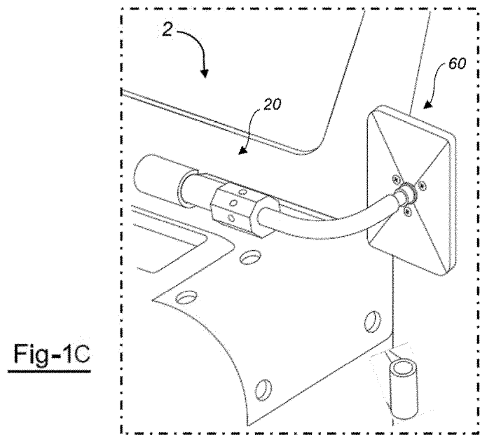

FIG. 2 shows an accessory adapter 30 and an accessory 60. The accessory adapter 30 has a vehicle side 32 and an accessory side 34. The accessory side 34 has an accessory bore 36 and one or more fastener bores 38. The accessory bore 36 includes a female rotation inhibitor 104. The accessory 60 includes a male segment 62, a lateral support 64, and an accessory body 68. The male segment 62 includes a groove 66 and a male rotation inhibitor 102.

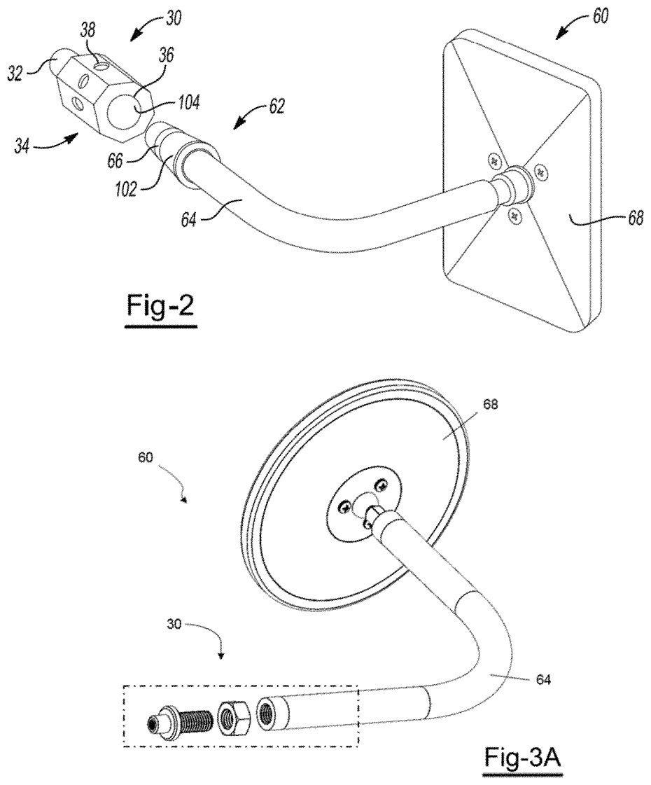

FIG. 3A shows an accessory 60 and accessory adapter 30. The accessory includes an accessory body 68 and a lateral support 64.

FIG. 3B shows a partial view of the accessory 60 and accessory adapter 30 of FIG. 3A. The accessory adapter 30 includes a vehicle side 32, an accessory side 34, and a fastening article 40. The accessory side 34 includes a male segment 62. The accessory 60 includes a lateral support 64 and a female segment 61. The fastening article 40 aligns with and threads onto the accessory side 34. Then the accessory side 34 aligns with and threads onto the female segment 61.

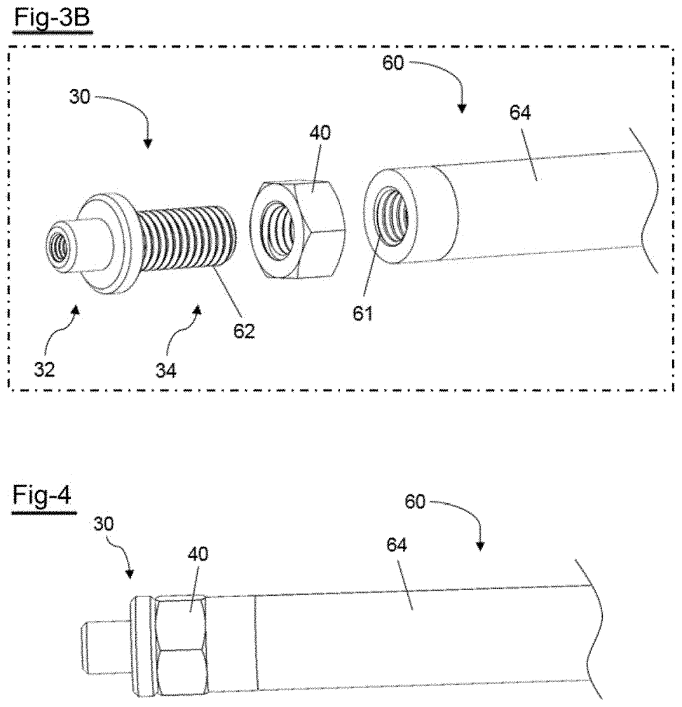

FIG. 4 shows an accessory 60 and accessory adapter 30. After the fastening article 40 is threaded onto the accessory adapter 30 and the accessory adapter 30 is threaded onto the lateral support 64 of the accessory 60, the fastening article 40 can be un-threaded to bias against the lateral support 64.

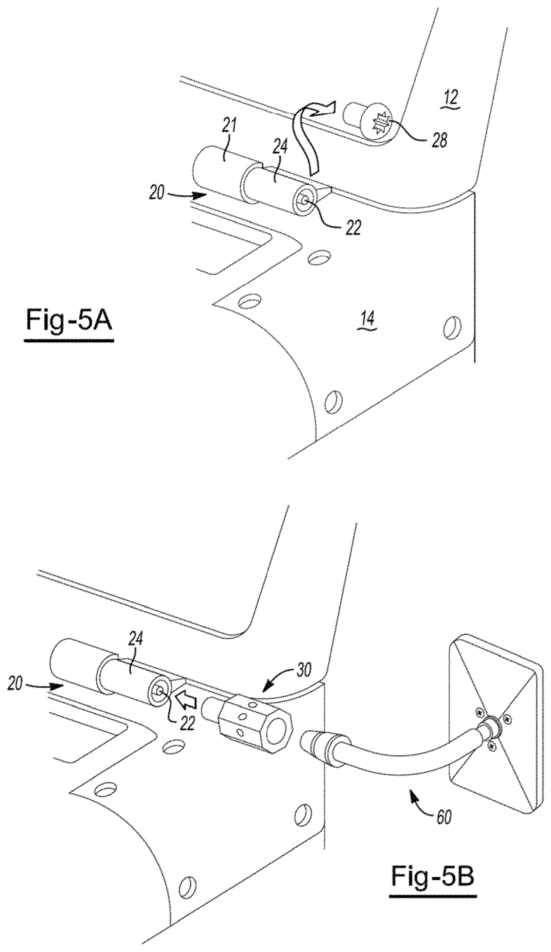

FIG. 5A shows the removal of the factory fastener 28 from the one or more windshield hinges 20. The one or more windshield hinges 20 connects the cowl 14 to the windshield frame 12. The one or more windshield hinges 20 includes a pin body 21, having a hinge pin 22, and hinge sleeve 24.

FIG. 5B shows the assembly of the accessory adapter 30 to the one or more windshield hinges 20 and assembly of the accessory 60 to the accessory adapter 30. The accessory adapter 30 fits in the hinge sleeve 24 and on the hinge pin 22.

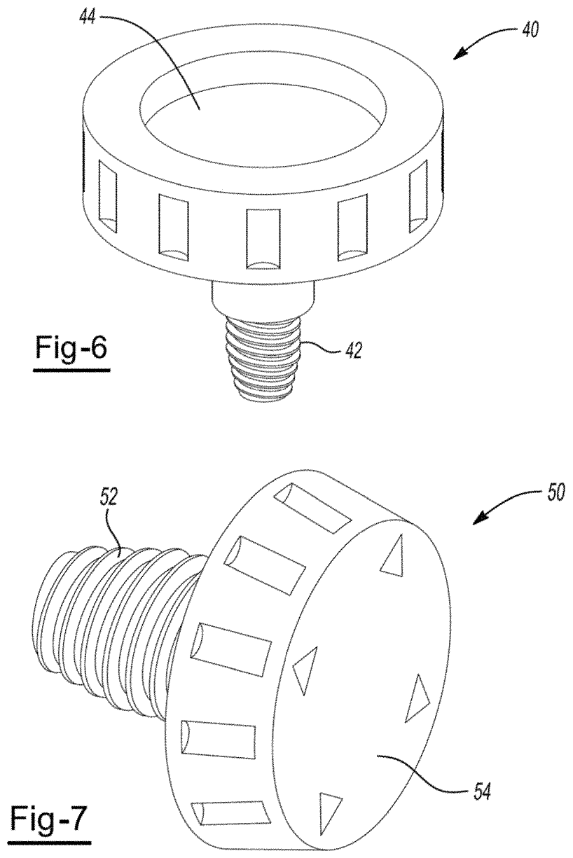

FIG. 6 illustrates a fastening article 40 having a locking member 42 and a fastener head 44.

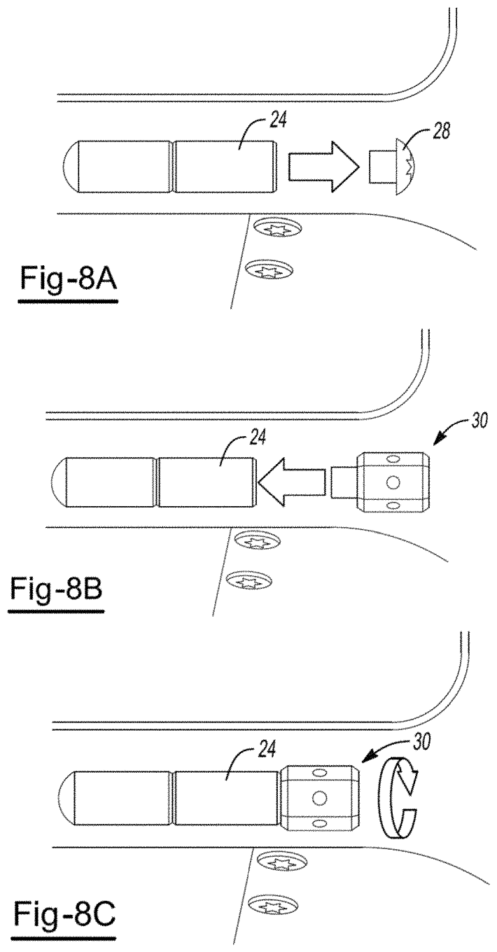

FIG. 7 illustrates a cap 50 having a cap insert 52 and a cap head 54.

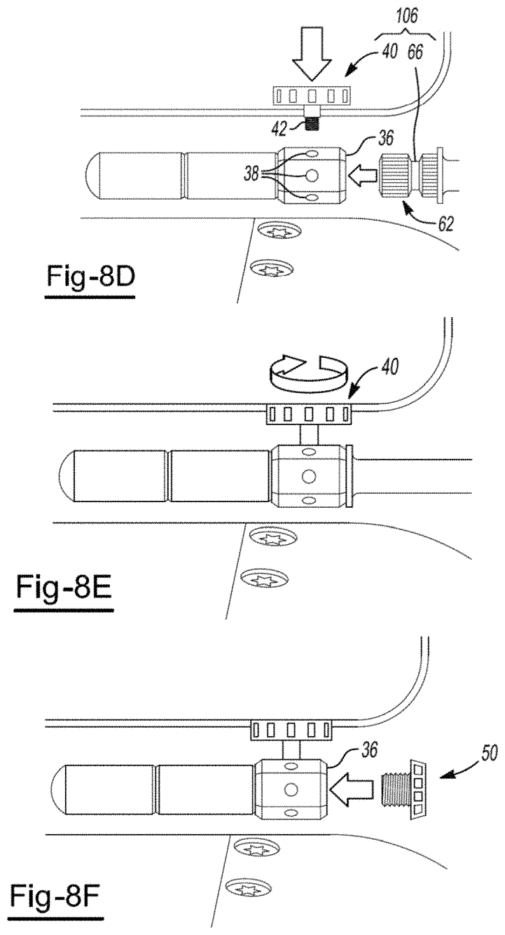

FIG. 8A shows removal of the factory fastener 28 from the hinge sleeve 24.

FIG. 8B shows assembly of the accessory adapter 30 with the hinge sleeve 24.

FIG. 8C shows rotation of the accessory adapter 30 about the hinge pin (not shown) within the hinge sleeve 24 to achieve a secure connection.

FIG. 8D shows alignment of the male segment 62 with the accessory bore 36 and a locking mechanism 106. The locking mechanism 106 includes the fastening article 40 and a groove 66. The locking member 42 of the fastening article 40 aligns with the one or more fastener bores 38. The male segment 62 has a groove 66 within which the locking member 42 fits to prevent retraction of the male segment out of the accessory bore 36.

FIG. 8E shows rotation of the fastening article 40, tightening the locking member (not shown) into the groove (not shown) of the male segment (not shown).

FIG. 8F shows assembly of the cap 50 with the accessory bore 36 when the male segment (not shown) is removed.

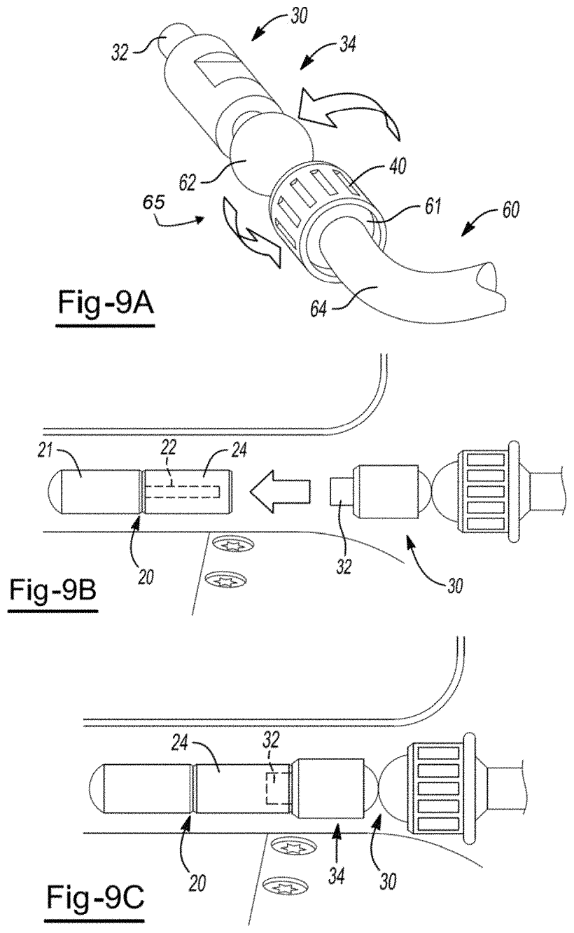

FIG. 9A shows the step of assembling the accessory 60 with the accessory adapter 30. The accessory adapter 30 includes a vehicle side 32 and an accessory side 34. The accessory side includes a male segment 62 including a connection member 65. The accessory 60 includes the lateral support 64, female segment 61, and fastening article 40. The female segment 61 of the accessory 60 and the male segment 62 of the accessory adapter 30 come together to form a rotatable connection. Once the male segment 62 is mated with the female segment 61, the fastening article 40 is installed so as to prevent the male segment 62 from being separated from the female segment 61.

FIG. 9B shows alignment of the accessory adapter 30 with the one or more windshield hinges 20. The one or more windshield hinges 20 includes a pin body 21 a hinge sleeve 24, and a hinge pin 22 extending, cantilever from the pin body 21, at least partially through the hinge sleeve 24. The vehicle side 32 fits within the hinge sleeve 24 and over the hinge pin 22.

FIG. 9C shows assembly of the accessory adapter 30 with the one or more windshield hinges 20. The vehicle side 32 of the accessory adapter 30 securedly fits within the hinge sleeve 24 of the one or more windshield hinges 20. The accessory side 34 sits flush against the hinge sleeve 24.

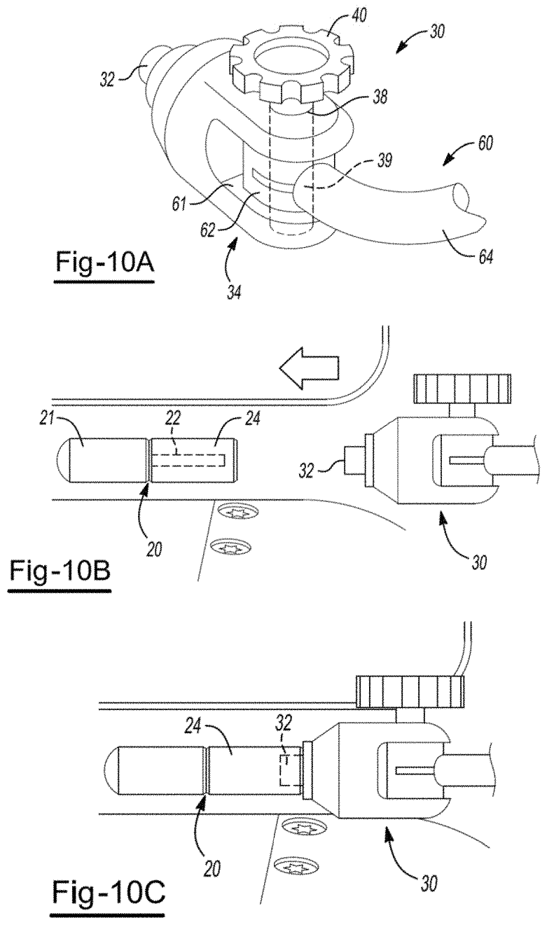

FIG. 10A shows an assembled accessory 60 and accessory adapter 30. The accessory adapter 30 includes a vehicle side 32 and an accessory side 34. The accessory side 34 includes a female segment 61 and one or more fastener bores 38. The accessory 60 includes the lateral support 64 and male segment 62. The vehicle side 32 includes one or more fastener bores 38, which aligns with a through-hole 39 that extends through the male segment 62. The male segment 62 of the accessory 60 and the female segment 61 of the accessory adapter 30 come together to form a rotatable connection. Once the male segment 62 is mated with the female segment 61, the fastening article 40 is installed so as to prevent the male segment 62 from being separated from the female segment 61. The fastening article 40 extends through the accessory side 60 and into the male segment 62.

FIG. 10B shows alignment of the accessory adapter 30 with the one or more windshield hinges 20. The one or more windshield hinges 20 includes a pin body 21, a hinge sleeve 24 and a hinge pin 22 extending cantilever from the pin body 21 at least partially through the hinge sleeve 24. The vehicle side 32 fits within the hinge sleeve 24 and over the hinge pin 22.

FIG. 10C shows assembly of the accessory adapter 30 with the one or more windshield hinges 20. The vehicle side 32 of the accessory adapter 30 securedly fits within the hinge sleeve 24 of the one or more windshield hinges 20.

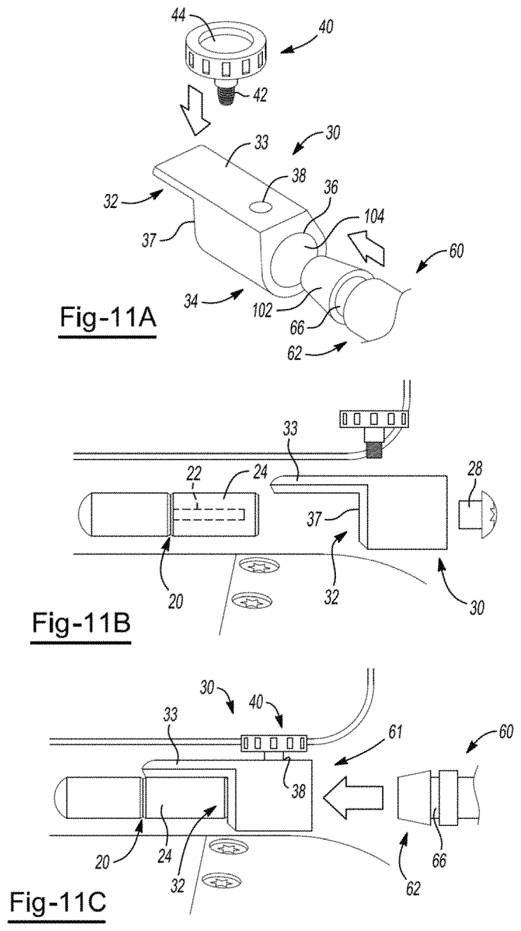

FIG. 11A shows an assembled accessory 60 and accessory adapter 30. The accessory adapter 30 includes a vehicle side 32 and an accessory side 34. The vehicle side 32 includes a support sleeve 33 and a hinge bore 37. The accessory side 34 includes an accessory bore 36 and one or more fastener bores 38. The accessory bore 36 has a female rotation inhibitor 104. The accessory 60 includes a male segment 62. The male segment 62 includes a male rotation inhibitor 102 and a groove 66. The male segment 62 of the accessory 60 and the female segment 61 of the accessory adapter 30 come together to form a static connection. Once the male segment 62 is mated with the female segment 61, the fastening article 40 is installed so as to prevent the male segment 62 from being separated from the female segment 61. The fastening article 40 includes a locking member 42 and a fastener head 44. The locking member 44 of the fastening article 40 extends through a fastener bore 38 in the accessory side 60 and into the groove 66 of the male segment 62. When the male rotation inhibitor 102 and the female rotation inhibitor 104 are mated, the complimentary fit prevents rotation of the accessory 60 with respect to the accessory adapter 30.

FIG. 11B shows alignment of the accessory adapter 30 with the one or more windshield hinges 20. The one or more windshield hinges 20 includes a hinge sleeve 24 and a hinge pin 22 extending at least partially through the hinge sleeve 24. The vehicle side 32 fits onto the hinge sleeve 24. The support sleeve 33 fits over the hinge sleeve 24. The factory fastener 28 extends through the hinge bore 37 and is secured to the hinge pin 22 and secures the accessory adapter 30 to the one or more windshield hinges 20.

FIG. 11C shows assembly of the accessory 60 with the accessory adapter 30. The vehicle side 32 of the accessory adapter 30 securedly fits within the hinge sleeve 24 of the one or more windshield hinges 20 and the support sleeve 33 extends over the one or more windshield hinges 20. After installation of the factory fastener (not shown), the male segment 62 of the accessory 60 is mated with the female segment 61 of the accessory adapter 30 and the fastening article 40 is placed through the one or more fastener bores 38 and into the groove 66.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer, “beneath,” “below,” “lower,” “above,” upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The disclosures of all articles and references, including patent applications and publications, are incorporated by reference for all purposes. Other combinations are also possible as will be gleaned from the following claims, which are also hereby incorporated by reference into this written description.

1. An accessory adapter comprising:
(a) vehicle side, attachable to a hinge of a vehicle, and
(b) an accessory side, wherein the accessory side is configured to accept an accessory.

2. The accessory adapter according to claim 1, wherein the one or more hinges of the vehicle is one or more windshield hinges.

3. The accessory adapter according to claim 2, wherein a windshield is free to rotate once the accessory adapter is attached to the hinge.

4. The accessory adapter according to claim 1, wherein the accessory adapter is configured to be installed, removed, or both free of tools and manually by hand.

5. The accessory adapter according to claim 1, wherein the accessory adapter includes an accessory bore that receives the accessory.

6. (canceled)

7. The accessory adapter according to claim 1, wherein the accessory side of the accessory adapter includes a female rotation inhibitor which prevent rotation of the accessory when the accessory is present in an accessory bore of the accessory side.

8-10. (canceled)

11. The accessory adapter according to any of claim 7, wherein the accessory adapter includes a locking mechanism that prevents axial movement of the accessory relative to the accessory adapter.

12. The accessory adapter according to claim 11, wherein the locking mechanism includes a fastening article that extends through a fastening bore along the accessory side of the accessory adapter.

13-20. (canceled)

21. An accessory assembly comprising:
(a) an accessory having an accessory body and a male segment, wherein the accessory body and the male segment are connected by a lateral support; and
(b) an accessory adapter in communication with the accessory, the accessory adapter having:
(1) a vehicle side that directly attaches to a hinge of a vehicle; and
(2) an accessory side that removably receives the male segment of the accessory.

22. The accessory assembly of claim 21, wherein the accessory side of the accessory adapter includes an accessory bore that receives the male segment of the accessory, and a female rotation inhibitor of the accessory bore prevents unwanted rotation of the accessory adapter after installation.

23. The accessory assembly of claim 22, wherein the accessory side of the accessory adapter includes a fastener bore, and a fastening article extends through the fastener bore to engage a groove along the male segment of the accessory, thereby preventing lateral movement of the accessory relative to the accessory adapter.

24. The accessory assembly of claim 23, wherein the fastening article includes a fastener head and a locking member, and the locking member is rotated into the fastener bore to engage the groove of the male segment.

25. The accessory assembly of claim 24, wherein the vehicle side of the accessory adapter includes internal threading to attach to the hinge of the vehicle.

26. The accessory adapter of claim 12, wherein the fastening article includes a fastener head and a locking member, and the locking member is rotated into the fastener bore to engage the accessory portion located within the accessory bore, thereby preventing lateral movement of the accessory relative to the accessory adapter.

27. The accessory adapter of claim 1, wherein the vehicle side of the accessory adapter includes internal threading to attach to the hinge of the vehicle.

28. The accessory adapter of claim 12, wherein the fastener bore is positioned along a surface of the accessory side that is transverse to a surface of the accessory side that includes that accessory bore.

29. The accessory adapter of claim 28, wherein the accessory bore has a diameter that is less than a diameter of the accessory bore.

30. The accessory adapter of claim 1, wherein the accessory side includes one or more flat surfaces, and the vehicle side is a toroid.

31. The accessory adapter of claim 30, wherein the accessory side have a diameter greater than a diameter of the vehicle side.

32. The accessory adapter of claim 7, further including a cap that is received, and at least partially secured within, the accessory bore when the accessory is disconnected from the accessory adapter.
